(19) United States
(12) Patent Application Publication
(10) Pub. No.: US 2014/0141774 A1
(43) Pub. Date: May 22, 2014

(54) Method and system for implementing intelligent roaming service

(71) Applicants: Na Jin, Shenzhen (CN); Xuqiang Zhou, Shenzhen (CN)

(72) Inventors: Na Jin, Shenzhen (CN); Xuqiang Zhou, Shenzhen (CN)

(73) Assignee: ZTE CORPORATION, Shenzhen, Guangdong (CN)

(21) Appl. No.: 14/130,997

(22) PCT Filed: Mar. 14, 2012
(86) PCT No.: PCT/CN2012/072323

§ 371 Date: Jan. 6, 2014

(30) Foreign Application Priority Data
Jul. 19, 2011 (CN) 201110202116.X

(51) Int. Cl. H04W 8/12

(52) U.S. Cl. CPC H04W 8/12
USPC 455/433

(57) ABSTRACT

An embodiment of the disclosure provides a method for implementing an intelligent roaming service. The method includes: when an one-card multi-number user terminal is powered on in a first country and selects a first number, a Home Location Register (HLR) of the first country sends a Handset Activity Triggers (HAT) message to a Service Control Point (SCP); and when the one-card multi-number user terminal roams to another country and a normal user terminal of the first country calls the first number corresponding to the first country of the one-card multi-number user terminal, the SCP switches, according to the HAT message, the first number to a number corresponding to the another country to which the one-card multi-number user terminal roams. The disclosure further provides a system for implementing an intelligent roaming service. With the solutions of the disclosure, the problem of expensive international roaming charge of the one-card multi-number user terminal is solved.

### TECHNICAL FIELD

The disclosure relates to the field of mobile communications, and in particular to a method and a system for implementing an intelligent roaming service.

### BACKGROUND

Along with the continuous development of telecommunications services in home and abroad markets, the number of travellers travelled between two countries is increasing, and requirements of international roaming services are also growing. However, cost of communication of users is increased due to expensive international roaming charges. Additionally, when an one-card multi-number user terminal enjoys the international roaming service, a Mobile Switching Center (MSC) of a roaming location requests user's subscription information for the intelligent roaming service from a Home Location Register (HLR). Some HLRs generally inhibit roaming of smart phone users abroad. That is, when the one-card multi-number user terminal is in international roaming, if the one-card multi-number user terminal is powered on, the MSC of a roaming location cannot acquire the user's subscription information for the intelligent roaming service from the HLR, so that this call is only processed by using a normal international roaming process, and the MSC will not send a message to an international intelligent network platform.

### SUMMARY

In view of this, embodiments of the disclosure are intended to provide a method and a system for implementing an intelligent roaming service, so as to solve the problem of expensive international roaming charge of an one-card multi-number user terminal.

To this end, technical solutions of the embodiments of the disclosure are implemented as follows.

A method for implementing an intelligent roaming service provided by an embodiment of the disclosure includes:

when an one-card multi-number user terminal is powered on in a first country and selects a first number, a Home Location Register (HLR) of the first country sends a Handset Activity Triggers (HAT) message to a Service Control Point (SCP); and

when the one-card multi-number user terminal roams to another country and a normal user terminal of the first country calls the first number corresponding to the first country of the one-card multi-number user terminal, the SCP switches, according to the HAT message, the first number to a number corresponding to the another country to which the one-card multi-number user terminal roams.

The above method may further include:

when the one-card multi-number user terminal is powered off in the first country, the HLR of the first country sends a Handset Inactive Trigger (HIT) message to the SCP, and the SCP updates a state of the one-card multi-number user terminal according to the HIT message.

In the above method, the step that an HLR of the first country sends an HAT message to an SCP may include:

the HLR of the first country sends a private HAT message to the SCP, wherein the private HAT message includes a Mobile Identification Number (MIN) of the one-card multi-number user terminal, a first Mobile Directory Number (MDN) and an Identifier (ID) of a Mobile Switching Center (MSC) of the first country; and

the SCP updates a state and current location information of the one-card multi-number user terminal locally stored according to information in the HAT message.

The above method may further include: before the HLR of the first country sends the private HAT message to the SCP,

the MSC of the first country sends a location update request message to the HLR of the first country; and

the HLR of the first country returns the MDN and user's subscription information for the intelligent roaming service to the MSC of the first country.

In the above method, the step that the SCP switches, according to the HAT message, the first number to a number corresponding to the another country to which the one-card multi-number user terminal roams may include:

an MSC of the first country sends a Location Request (LOCREQ) request message to the HLR of the first country;

the HLR of the first country returns the user's subscription information for the intelligent roaming service of the called one-card multi-number user terminal to the MSC of the first country through an LOCREQ response message;

the MSC of the first country sends an Analyzed Information (ANLYZD) message to the SCP according to the user's subscription information for the intelligent roaming service; and

when it is determined by the SCP, according to the HAT message sent by the HLR when the one-card multi-number user terminal is powered on, that the called number is the first number of the one-card multi-number user terminal and that the one-card multi-number user terminal currently roams to the another country, the SCP switches the first number to the number corresponding to the another country to which the one-card multi-number user terminal currently roams.

The above method may further include:

the SCP sends to the MSC of the first country the number corresponding to the another country to which the one-card multi-number user terminal currently roams;

the MSC of the first country sends an Initial Address Massage (IAM) to an MSC of the country to which the one-card multi-number user terminal currently roams;

the MSC of the another country to which the one-card multi-number user terminal currently roams sends an LOCREQ request message to a local HLR;

an HLR of the another country to which the one-card multi-number user terminal currently roams sends the user's subscription information for the intelligent roaming service of the number corresponding to the another country to which the one-card multi-number user terminal currently roams, of the called one-card multi-number user terminal to the SCP through a local MSC;

the SCP sends an ANLYZD response message to the MSC of the another country to which the one-card multi-number user terminal currently roams, according to the user's subscription information for the intelligent roaming service;

the MSC of the another country to which the one-card multi-number user terminal currently roams sends an Address Complete Message (ACM) and an Answer Message (ANM) to the MSC of the first country to establish a connection; and

the MSC of the another country to which the one-card multi-number user terminal currently roams gets through the number corresponding to the another country to which the one-card multi-number user terminal currently roams, and thereby a connection between a calling number and a called number is established.

In the above method, the step that the HLR of the first country sends an HIT message to the SCP, and the SCP updates a state of the one-card multi-number user terminal according to the HIT message may include:

the HLR of the first country sends a private HIT message to the SCP, wherein the private HIT message includes an MIN of the one-card multi-number user terminal, a first MDN and an ID of an MSC of the first country; and

the SCP updates a state and current location information of one-card multi-number user terminal locally stored, and modifies the state of the one-card multi-number user terminal from a power-on state to a power-off state.

The above method may further include: before the HLR of the first country sends the private HIT message to the SCP,

the MSC of the first country sends a power-off request message to the HLR of the first country according to a first IMSI number of the one-card multi-number user terminal; and

the HLR of the first country returns a power-off request acknowledgement message to the MSC of the first country.

An embodiment of the disclosure further provides a system for implementing an intelligent roaming service, which include: a Home Location Register (HLR) of a first country and a Service Control Point (SCP), wherein

the HLR of the first country is configured to, when an one-card multi-number user terminal is powered on in the first country and selects a first number, send a Handset Activity Triggers (HAT) message to the SCP; and

the SCP is configured to, when the one-card multi-number user terminal roams to another country and a normal user terminal of the first country calls the first number corresponding to the first country of the one-card multi-number user terminal, switch, according to the HAT message, the first number to a number corresponding to the another country to which the one-card multi-number user terminal roams.

In the above system, the HLR of the first country is further configured to, when the one-card multi-number user terminal is powered off in the first country, send a Handset Inactive Trigger (HIT) message to the SCP; and

the SCP is further configured to update a state of the one-card multi-number user terminal according to the HIT message.

According to the method and the system for implementing an intelligent roaming service provided by the embodiments of the disclosure, when an one-card multi-number user terminal is powered on in a first country and selects a first number, an HLR of the first country sends an HAT message to an SCP; and when the one-card multi-number user terminal roams to another country and a normal user terminal of the first country calls the first number corresponding to the first country of the one-card multi-number user terminal, the SCP switches, according to the HAT message, the first number to a number corresponding to the another country to which the one-card multi-number user terminal roams. When the one-card multi-number user terminal roams to a certain country and is called, a number of the roaming country can be called through directly, so that the international roaming service charge of the called party may be saved, thus solving the problem of expensive international roaming charge of the one-card multi-number user terminal and reducing a circuitous telephone channel. Additionally, it is solved that when the one-card multi-number user terminal enjoys an international roaming service and is powered on, an intelligent roaming service cannot be triggered since an MSC of the roaming location cannot obtain the user's subscription information for the intelligent roaming service from the HLR. When the one-card multi-number user terminal calls a certain number of the home country, the one-card multi-number user terminal can select a number corresponding to the home country of its multiple numbers to call the certain number, so as to reduce charges and avoid miscall.

### BRIEF DESCRIPTION OF THE DRAWINGS

FIG. 1 is a flowchart of a method for implementing an intelligent roaming service according to an embodiment of the disclosure;

FIG. 2 is a flowchart of a specific method for implementing step 101 in the embodiment of the disclosure;

FIG. 3 is a network diagram of the method for implementing an intelligent roaming service according to the embodiment of the disclosure;

FIG. 4 is a flowchart of a specific method for implementing step 102 in the embodiment of the disclosure;

FIG. 5 is a flowchart of a specific method for implementing step 103 in the embodiment of the disclosure; and

FIG. 6 is a structural diagram of a system for implementing an intelligent roaming service according to an embodiment of the disclosure.

### DETAILED DESCRIPTION

The basis idea of the disclosure is that: when an one-card multi-number user terminal is powered on in a first country and selects a first number, an HLR of the first country sends an HAT message to an SCP; and when the one-card multi-number user terminal roams to another country and a normal user terminal of the first country calls the first number corresponding to the first country of the one-card multi-number user terminal, the SCP switches, according to the HAT message, the first number to a number corresponding to the another country to which the one-card multi-number user terminal roams.

Hereinafter, the disclosure will be further elaborated with reference to the drawings and specific embodiments.

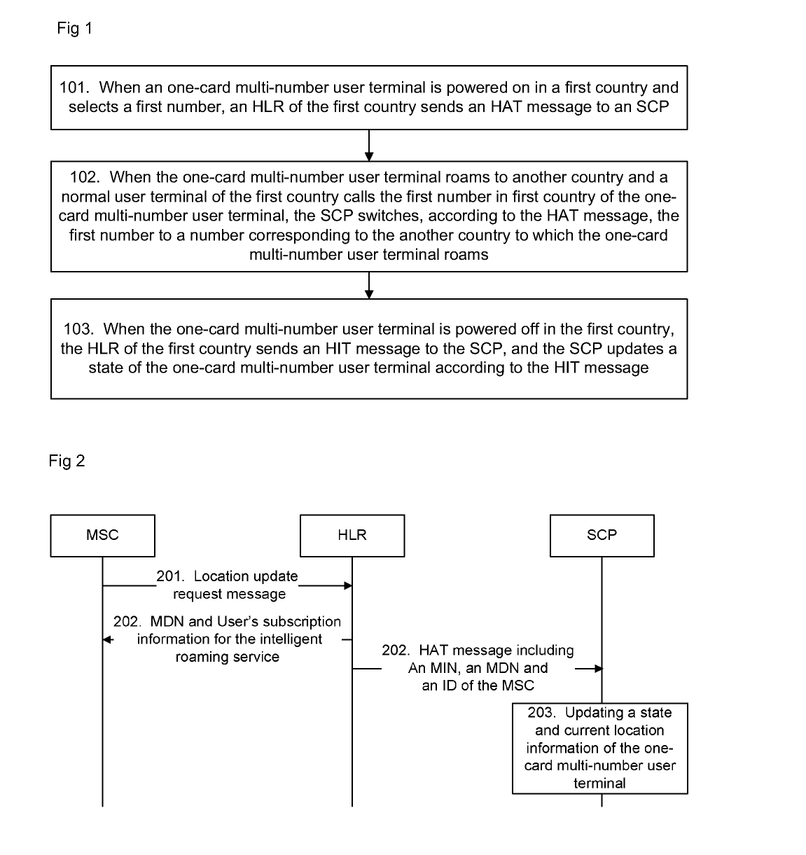

An embodiment of the disclosure provides a method for implementing an intelligent roaming service. FIG. 1 is a flowchart of a method for implementing an intelligent roaming service according to the embodiment of the disclosure. As shown in FIG. 1, the method includes the following steps:

Step 101: When an one-card multi-number user terminal is powered on in a first country and selects a first number, a Home Location Register (HLR) of the first country sends a Handset Activity Triggers (HAT) message to a Service Control Point (SCP).

Step 102: When the one-card multi-number user terminal roams to another country and a normal user terminal of the first country calls the first number corresponding to the first country of the one-card multi-number user terminal, the SCP switches, according to the HAT message, the first number to a number corresponding to the another country to which the one-card multi-number user terminal roams.

Step 103: When the one-card multi-number user terminal is powered off in the first country, the HLR of the first country sends a Handset Inactive Trigger (HIT) message to the SCP, and the SCP updates a state of the one-card multi-number user terminal according to the HIT message.

FIG. 2 is a flowchart of a specific method for implementing step 101 in the embodiment of the disclosure, which shows a specific method for implementing that the HLR of the first country sends the HAT message to the SCP when the one-card multi-number user terminal is powered on in the first country and selects the first number. As shown in FIG. 2, the method includes the following steps:

Step 201: When the one-card multi-number user terminal is powered on in the first country and selects the first number corresponding to the first country from multiple numbers, the MSC of the first country sends a location update request Register Notice (REGNOT) message to the HLR of the first country according to an IMSI (International Mobile Subscriber Identification) of the one-card multi-number user terminal.

Step 202: After the REGNOT message is received, the HLR of the first country returns a first Mobile Directory Number (MDN) and user's subscription information for the intelligent roaming service to an MSC of the first country; the user's subscription information for the intelligent roaming service is user's subscription information for the intelligent roaming service of the one-card multi-number user terminal; and

the HLR of the first country sends a private HAT message to the SCP, and the private HAT message includes an MIN (Mobile Identification Number) of the one-card multi-number user terminal, a first MDN and an ID of the MSC of the first country. The private HAT message is used to inform the SCP of a latest state and current location information the one-card multi-number user terminal. Here, the one-card multi-number user terminal is in a power-on state.

Step 203: the SCP updates a locally stored state and locally stored current location information of the one-card multi-number user terminal according to information in the HAT message.

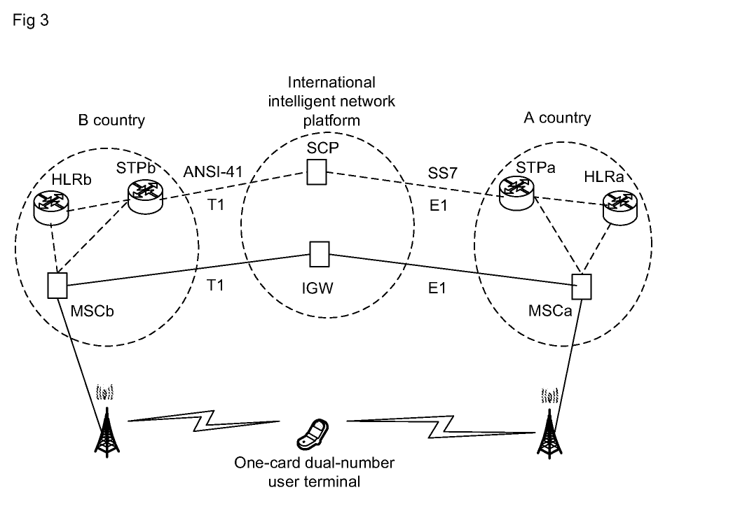

For example, as shown in FIG. 3, an one-card dual-number user terminal applies for an SIM card having two MDNs firstly, in which one MDN is a number of A country and another one is b number of B country. The a number subscribes the intelligent roaming service, which is directed to an SCP, in an HLRa of the A country; and the b number subscribes the intelligent roaming service, which is directed to the same SCP, in an HLRb of the B country; when the one-card dual-number user terminal is powered on in the B country and selects the b number and an MSCb of the B country sends a REGNOT message to the HLRb, the HLRb sends a private HAT message to the SCP, and the service side of the SCP updates, according to an MIN, an MDNb and an ID of the MSCb in the received HAT message, a state and current location information of the one-card dual-number user terminal corresponding to the MDNb.

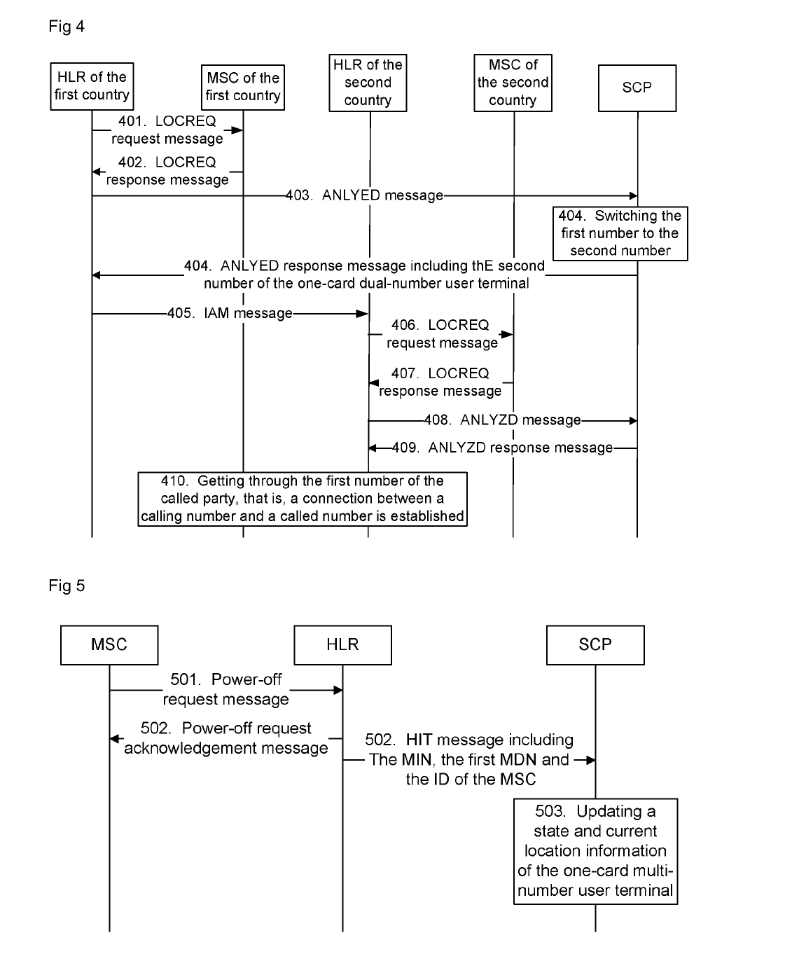

FIG. 4 is a flowchart of a specific method for implementing step 102 in the embodiment of the disclosure. In the embodiment of the disclosure, another country includes one or more countries. Descriptions are made below by taking, for an example, the case that the one-card multi-number user terminal is an one-card dual-number user terminal and the one-card dual-number user terminal roams to a second country. As shown in FIG. 4, the method includes the following steps:

Step 401: When the normal user terminal of the first country calls the first number corresponding to the first country of the one-card dual-number user terminal, the MSC of the first country sends a Location Request (LOCREQ) request message to the HLR of the first country corresponding to the called one-card dual-number user terminal to request to acquire user's subscription information for the intelligent roaming service of the one-card dual-number user terminal.

Step 402: The HLR of the first country returns the user's subscription information for the intelligent roaming service of the called one-card dual-number user terminal to the MSC of the first country through an LOCREQ response message.

Step 403: The MSC of the first country sends an Analyzed Information (ANLYZD) message to the SCP according to the user's subscription information for the intelligent roaming service of the one-card dual-number user terminal.

Step 404: After the ANLYZD message is received, the SCP determines, according to the HAT message which is sent by the HLR when the one-card dual-number user terminal is powered on, that the called number is the first number of the one-card dual-number user terminal and the one-card dual-number user terminal currently roams to the second country, then the SCP performs number switching, that is, the SCP switches the first number to a second number corresponding to the second country, and returns an ANLYZD response message to the MSC of the first country. A routing number included in the ANLYZD response message is the second number of the called one-card dual-number user terminal.

Step 405: The MSC of the first country sends an Initial Address Message (IAM) to an MSC of the second country to call the second number of the one-card dual-number user terminal.

Step 406: After the IAM is received, the MSC of the second country sends an LOCREQ request message to an HLR of the second country to request to acquire user subscription information for the intelligent roaming service of the second number of the called one-card dual-number user terminal

Step 407: The HLR of the second country sends the user subscription information for the intelligent roaming service of the second number of the called one-card dual-number user terminal to the MSC of the second country through an LOCREQ response message.

Step 408: The MSC of the second country sends, according to the user subscription information for the intelligent roaming service of the second number of the called one-card dual-number user terminal, an ANLYZD message, which includes the user subscription information for the intelligent roaming service of the second number of the called one-card dual-number user terminal, to the SCP to trigger the called process of the one-card dual-number user terminal.

Step 409: The SCP determines, according to the user subscription information for the intelligent roaming service included in the ANLYZD message, that the called number is the second number of the one-card dual-number user terminal, and sends an ANLYZD response message to the MSC of the second country.

Step 410: The MSC of the second country sends an Address Complete Message (ACM) and an Answer Message (ANM) to the MSC of the first country to establish a connection; if the one-card dual-number user terminal is in the power-on state, the MSC of the second country can get through the called second number, that is, a connection between a calling terminal and a called terminal is established.

FIG. 5 is a flowchart of a specific method for implementing step 103 in the embodiment of the disclosure, which shows the detailed process that when the one-card multi-number user terminal is powered off in the first country, the HLR of the first country sends the HIT message to the SCP, and the SCP updates the state of the one-card multi-number user terminal according to the HIT message. As shown in FIG. 5, the method includes the following steps.

Step 501: When the one-card multi-number user terminal is powered off in the first country, the MSC of the first country sends a power-off request (MSInactive) message to the HLR of the first country according to a first IMSI number of the one-card multi-number user terminal.

Step 502: After the power-off request message is received, the HLR of the first country sends a power-off request acknowledgement message to the MSC of the first country to inform the MSC of the first country that the power-off request message is received; and

the HLR of the first country sends the private HIT message to the SCP, in which includes the MIN of the one-card multi-number user terminal, the first MIN and the ID for the MSC of the first country; the HIT message is used to inform the SCP of the latest state and current location information of the one-card multi-number user terminal; here, the latest state of the one-card multi-number user terminal is the power-off state.

Step 503: The SCP updates a state and current location information of the one-card multi-number user terminal locally stored according to the information in the HIT message, and modifies the state of the one-card multi-number user terminal to the power-off state from the power-on state.

For example, when the one-card dual-number user terminal is powered on in the B country and selects the b number and then is powered off, the MSCb of the B country sends an MSInactive message to the HLRb, then the HLRb sends a private HIT message to the SCP, and the service side of the SCP updates the state and current location information of the one-card dual-number user terminal.

In the above embodiment, through two private messages, i.e., the HAT message and the HIT message, it can be implemented that when the one-card multi-number user terminal is powered off, the SCP is notified timely to update the state and current location information of the one-card multi-number user terminal.

### Embodiment

At present, a Mobile Virtual Network Operators (MVNO) service cooperated by the ZTE Corporation and the China Telecom of America (CTA) is a service for an one-card multi-number user terminal. The problem of automatic roaming of two numbers between America and China can be solved in the one-card multi-number mode as long as one one-card multi-number user terminal and one SIM card are used. For example, if a China Telecom CDMA user needs to go to America, the user starts the MVNO service before departure, and applies for one SIM card with two IMSI numbers, of which one is a Chinese number provided by the China Telecom and another is an American number provided by the America Sprint corporation. Thus, when the user roams between America and China and the user terminal is powered on, the user can freely select anyone network and make a call using the IMSI number of anyone country, and another user can get through the user terminal through calling anyone number of the SIM card.

The process that the one-card dual-number user terminal of the MVNO service is powered on and selects the American number is as follows.

Step 1: The one-card dual-number user terminal is powered on in America, and selects an American IMSIb number; and the American MSCb number sends, according to the IMSIb number of the one-card dual-number user terminal, a location update request message to an HLRb in America to which the American IMSIb number is belonged.

Step 2: The HLRb returns an MDNb and user's subscription information for the intelligent roaming service to the MSCb.

Step 3: The HLRb sends an HAT message to an SCP of an international intelligent network platform to notify the SCP that the one-card dual-number user terminal is powered on and selects the American number; and the service side of the SCP modifies location information of the one-card dual-number user terminal as America according to an MIN in the received HAT message, an MDN matched based on configuration and an ID of the MSCb.

The process that a Chinese normal user terminal calls the Chinese number of the one-card dual-number user terminal of the MVNO service in America is as follows.

Step 1: The Chinese normal user terminal calls the Chinese number of the one-card dual-number user terminal.

Step 2: The MSCa of China sends an LOCREQ request message to the HLRa, to which the called number belongs, of China to obtain user's subscription information for the intelligent roaming service, the HLRa to which the called number belongs returns the user's subscription information for the intelligent roaming service to the MSCa of China through an LOCREQ response message.

Step 3: The MSCa of China sends an ANLYZD message to the SCP of international intelligent network platform according to the user's subscription information for the intelligent roaming service.

Step 4: The SCP determines, according to user number information recorded when the one-card dual-number user terminal is powered on, that the called number is the Chinese number of the one-card dual-number user terminal and the one-card dual-number user terminal is being in America, and then the SCP performs number switching and sends the American number of the called one-card dual-number user terminal as a routing number to the MSCa of China through an ANLYZD response message.

Step 5: The MSCa of China sends an IMA message to the MSCb of America to call the American number of the one-card dual-number user terminal.

Step 6: The MSCb of America sends an LOCREQ request message to the HLRb of America to request to acquire user's subscription information for the intelligent roaming service of the American number of the one-card dual-number user terminal.

Step 7: The HLRb of America returns the user subscription information for the intelligent roaming service of the American number of the one-card dual-number user terminal to the MSCb in America through an LOCREQ response message.

Step 8: The MSCb of America sends an ANLYZD message to the SCP according to the user subscription information for the intelligent roaming service of the American number, to trigger the called process of the one-card dual-number user terminal.

Step 9: The SCP determines that the called number is the American number of the one-card dual-number user terminal of the MVNO service, and sends an ANLYZD response message to the MSCb of America.

Step 10: The MSCb of America sends an ACM and an ANM to the MSCa of China to continue the subsequent process.

Step 11: The MSCb of America gets through the American number of the called one-card dual-number user terminal, and thereby a connection between a calling terminal and a called terminal is established.

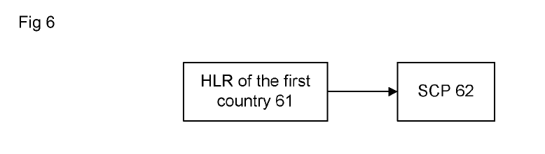

In order to achieve the above method, the disclosure also provides a system for implementing an intelligent roaming service. FIG. 6 is a structural diagram of the system for implementing an intelligent roaming service according to an embodiment of the disclosure. As shown in FIG. 6, the system includes an HLR 61 of a first country and an SCP 62.

The HLR 61 of the first country is configured to, when an one-card multi-number user terminal is powered on in the first country and selects a first number, send an HAT message to the SCP 62.

The SCP 62 is configured to, when the one-card multi-number user terminal roams to another country and a normal user calls the first number corresponding to the first country of the one-card multi-number terminal, switch, according to the HAT message, the first number to a number corresponding to the another country to which the one-card multi-number user terminal roams.

The HLR 61 of the first country is further configured to, when the one-card multi-number user terminal is powered off in the first country, to send an HIT message to the SCP 62.

The SCP 62 is further configured to update a state of the one-card multi-number user terminal according to the HIT message.

The process that the HLR 61 of the first country sends the HAT message to the SCP 62 includes: the HLR of the first country sends the SCP a private HAT message, in which includes the MIN of the one-card multi-number user terminal, the first MDN and ID of the MSC of the first country; and the SCP updates a state and current location information of the one-card multi-number user terminal according to information in the HAT message.

The process that the SCP 62 switches, according to the HAT message, the first number to the number corresponding to the another country to which the one-card multi-number user terminal currently roams includes: the MSC of the first country sends an LOCREQ request message to the HLR of the first country; the HLR of the first country returns user's subscription information for the intelligent roaming service of the called one-card multi-number user terminal to the MSC of the first country through an LOCREQ response message; the MSC of the first country sends an ANLYZD message to the SCP according to the user's subscription information for the intelligent roaming service; the SCP determines, according to the HAT message which is sent by the HLR when the one-card dual-number user terminal is powered on, that the called number is the first number of the one-card multi-number user terminal and the one-card multi-number user terminal currently roams to another country, and then the SCP switches the first number to the number corresponding to the another country to which the one-card multi-number user terminal currently roams.

The process that the HLR 61 of the first country sends the HIT message to the SCP 62 and the SCP 62 updates the state of the one-card multi-number user terminal according to the HIT message includes: the HLR of the first country sends a private

HIT message to the SCP, wherein the private HIT message includes an MIN of the one-card multi-number user terminal, a first MDN and an ID of the MSC of the first country; and the SCP updates the state and current location information of the one-card multi-number user terminal locally stored according to information in the HIT message, and changes the state of the one-card multi-number user terminal to the power-off state from the power-on state.

The above are only preferable embodiments of the disclosure, and are not intended to limit the scope of protection of the claims of the disclosure. Any modifications, equivalent substitutions, improvements or the like made within the concept and principle of the disclosure shall fall within the scope of protection of the claims of the disclosure.

1. A method for implementing an intelligent roaming service, comprising:
when an one-card multi-number user terminal is powered on in a first country and selects a first number, sending, by a Home Location Register (HLR) of the first country, a Handset Activity Triggers (HAT) message to a Service Control Point (SCP); and
when the one-card multi-number user terminal roams to another country and a normal user terminal of the first country calls the first number corresponding to the first country of the one-card multi-number user terminal, switching, by the SCP, according to the HAT message, the first number to a number corresponding to the another country to which the one-card multi-number user terminal roams.

2. The method according to claim 1, further comprising:
when the one-card multi-number user terminal is powered off in the first country, sending, by the HLR of the first country, a Handset Inactive Trigger (HIT) message to the SCP, and updating, by the SCP, a state of the one-card multi-number user terminal according to the HIT message.

3. The method according to claim 1, wherein the step of sending, by an HLR of the first country, an HAT message to an SCP comprises:
sending, by the HLR of the first country, a private HAT message to the SCP, wherein the private HAT message includes a Mobile Identification Number (MIN) of the one-card multi-number user terminal, a first Mobile Directory Number (MDN) and an Identifier (ID) of a Mobile Switching Center (MSC) of the first country; and
updating, by the SCP, a state and current location information of the one-card multi-number user terminal locally stored according to information in the HAT message.

4. The method according to claim 3, further comprising: before the HLR of the first country sends the private HAT message to the SCP,
sending, by the MSC of the first country, a location update request message to the HLR of the first country; and
returning, by the HLR of the first country, the MDN and user's subscription information for the intelligent roaming service to the MSC of the first country.

5. The method according to claim 1, wherein the step of switching, by the SCP, according to the HAT message, the first number to a number corresponding to the another country to which the one-card multi-number user terminal roams comprises:
sending, by an MSC of the first country, a Location Request (LOCREQ) request message to the HLR of the first country;
returning, by the HLR of the first country, the user's subscription information for the intelligent roaming service of the called one-card multi-number user terminal to the MSC of the first country through an LOCREQ response message;
sending, by the MSC of the first country, an Analyzed Information (ANLYZD) message to the SCP according to the user's subscription information for the intelligent roaming service; and
when it is determined by the SCP, according to the HAT message sent by the HLR when the one-card multi-number user terminal is powered on, that the called number is the first number of the one-card multi-number user terminal and that the one-card multi-number user terminal currently roams to the another country, switching, by the SCP, the first number to the number corresponding to the another country to which the one-card multi-number user terminal currently roams.

6. The method according to claim 5, further comprising:
sending, by the SCP, to the MSC of the first country the number corresponding to the another country to which the one-card multi-number user terminal currently roams;
sending, by the MSC of the first country, an Initial Address Massage (IAM) to an MSC of the country to which the one-card multi-number user terminal currently roams;
sending, by the MSC of the another country to which the one-card multi-number user terminal currently roams, an LOCREQ request message to a local HLR;
sending, by an HLR of the another country to which the one-card multi-number user terminal currently roams, the user's subscription information for the intelligent roaming service of the number corresponding to the another country to which the one-card multi-number user terminal currently roams, of the called one-card multi-number user terminal to the SCP through a local MSC;
sending, by the SCP, an ANLYZD response message to the MSC of the another country to which the one-card multi-number user terminal currently roams, according to the user's subscription information for the intelligent roaming service;
sending, by the MSC of the another country to which the one-card multi-number user terminal currently roams, an Address Complete Message (ACM) and an Answer Message (ANM) to the MSC of the first country to establish a connection; and
getting through, by the MSC of the another country to which the one-card multi-number user terminal currently roams, the number corresponding to the country to which the one-card multi-number user terminal currently roams, and thereby a connection between a calling number and a called number is established.

7. The method according to claim 2, wherein the sending, by the HLR of the first country, an HIT message to the SCP, and updating, by the SCP, a state of the one-card multi-number user terminal according to the HIT message comprises:
sending, by the HLR of the first country, a private HIT message to the SCP, wherein the private HIT message includes an MIN of the one-card multi-number user terminal, a first MDN and an ID of an MSC of the first country; and
updating, by the SCP, a state and current location information of one-card multi-number user terminal locally stored, and modifying the state of the one-card multi-number user terminal from a power-on state to a power-off state.

8. The method according to claim 7, further comprising: before the HLR of the first country sends the private HIT message to the SCP,
sending, by the MSC of the first country, a power-off request message to the HLR of the first country according to a first IMSI number of the one-card multi-number user terminal; and
returning, by the HLR of the first country, a power-off request acknowledgement message to the MSC of the first country.

9. A system for implementing an intelligent roaming service, comprising: a Home Location Register (HLR) of a first country and a Service Control Point (SCP), wherein
the HLR of the first country is configured to, when an one-card multi-number user terminal is powered on in the first country and selects a first number, send a Handset Activity Triggers (HAT) message to the SCP; and
the SCP is configured to, when the one-card multi-number user terminal roams to another country and a normal user terminal of the first country calls the first number corresponding to the first country of the one-card multi-number user terminal, switch, according to the HAT message, the first number to a number corresponding to the another country to which the one-card multi-number user terminal roams.

10. The system according to claim 9, wherein
the HLR of the first country is further configured to, when the one-card multi-number user terminal is powered off in the first country, send a Handset Inactive Trigger (HIT) message to the SCP; and
the SCP is further configured to update a state of the one-card multi-number user terminal according to the HIT message.
